(19) United States
(12) Patent Application Publication
(10) Pub. No.: US 2012/0090001 A1
(43) Pub. Date: Apr. 12, 2012

(54) APPARATUS HAVING MULTIMEDIA INTERFACE AND NETWORK ACCESS MANAGEMENT INTEGRATED THEREIN

(76) Inventor: Tzu-Chiang Yen, Hsinchu City (TW)

(21) Appl. No.: 13/237,953

(22) Filed: Sep. 21, 2011

Related U.S. Application Data
(60) Provisional application No. 61/390,618, filed on Oct. 7, 2010.

(51) Int. Cl. H04N 21/4147; H04N 5/445

(52) U.S. Cl. 725/37; 725/110; 725/88

(57) ABSTRACT

An apparatus includes a multimedia interface module and a network module. The multimedia interface module has a plurality of connection ports including at least an input port and at least an output port, and supports network data transmission. The network module, coupled to the multimedia interface module via a first network protocol, is for accessing a network, wherein the multimedia interface module is arranged for selectively coupling the network module to one of the connection ports.

### CROSS REFERENCE TO RELATED APPLICATIONS

This application claims the benefit of U.S. provisional application No. 61/390,618, which was filed on Sep. 7, 2010 and entitled “HOME NETWORK AND MANAGEMENT WITH HDMI INTEGRATED” and is incorporated herein by reference.

### BACKGROUND OF THE INVENTION

1. Field of the Invention

The present invention relates to a device equipped with a multimedia interface and a network interface to stream, play back and manage the content, along with network-protocol-based data traffic, cross whole multimedia interface connection to an audio/video output apparatus. It also relates to using the multimedia interface to manage other devices through a screen of the audio/video output apparatus or even remotely manage value-added services.

2. Description of the Prior Art

Nowadays, High-Definition Multimedia Interface (HDMI) is used as the major audio/video (A/V) transmission interface between a television (TV) and media appliances, such as Set-Top Boxes (STB), Digital Video Recorders/Personal Video Recorders (DVR/PVR), game consoles, Digital Video Disc/Blue-ray Disc (DVD/BD) players, and Over-The-Top (OTT) video devices, and mobile devices. Actually, the trends show that HDMI is getting to replace other legacy A/V interfaces while High-Definition Television (HDTV) becomes a mainstream. With HDMI supporting Ethernet (HDMI Ethernet Channel, HEC) and Consumer Electronic Control (CEC), HDMI can play a role more than simple A/V transmission interface.

Please refer to FIG. 1, which is a diagram illustrating a typical network system with HEC. As shown in FIG.1, a TV 110 supporting HDMI HEC is connected to one or a plurality of Internet-Protocol-enabled (IP-enabled) home devices (e.g., a DVD player 120, a DVR 130, and/or a gaming console 140) via HDMI interfaces. Those connected devices can share an Internet connection to eliminate the need for separate Ethernet cables.

Even if HEC is implemented, a home network infrastructure is still needed to switch and/or route the network packet traffic to Internet. For example, Local Area Network (LAN) switching and/or IP routing functionality may be required to be integrated with HDMI to ease the connectivity issues, especially in a condition where broadband connection is located far away from the TV or the media appliances. On the other hand, the TV and the media appliances also can be managed by typical home network management protocols through interfacing with CEC via HDMI integrated.

Hence, how to design and integrate network accessing and management with audio/video output apparatuses through the multimedia interface supporting network data transmission becomes an important topic in this field.

### SUMMARY OF THE INVENTION

It is therefore one of the objectives of the claimed invention to provide an apparatus having a multimedia interface module and a network module integrated, which not only eases internet connectivity issues but also manages devices connected to an audio/video output apparatus.

According to an embodiment of the present invention, an exemplary apparatus is disclosed. The exemplary apparatus includes a multimedia interface module and a network module. The multimedia interface module has a plurality of connection ports including at least an input port and at least an output port, and supports network data transmission. The network module, coupled to the multimedia interface module via a first network protocol, is for accessing a network, wherein the multimedia interface module is arranged for selectively coupling the network module to one of the connection ports.

The exemplary multimedia interface module only transfers non network-related multimedia interface data to a multimedia-interface-enabled audio/video output apparatus for audio/video playback of an output generated from the output port of the apparatus, and network-related multimedia interface data is processed by the network module together with other network data from an external device.

Furthermore, the exemplary apparatus may also communicate with at least an external source device via a second network protocol, and the external source device does not support network-related multimedia interface data, wherein the external source device may be an HDMI device or an IP-enabled device not supporting HDMI. The exemplary apparatus may be externally coupled to, or built in, the audio/video output apparatus.

According to another embodiment of the present invention, the exemplary apparatus further comprises a user interface controller, and the user interface controller is coupled to the network module, for generating a first control signal according to a user input signal, and transmitting a second control signal to an external source device coupled to the network module. The user interface controller drives a display screen to display a user interface, and the user input signal is generated according to the displayed user interface. In addition, the user interface controller also receives a sensor input signal generated from a sensor device coupled to the network module, and drives a display screen to display information of the sensor device according to the sensor input signal. In this embodiment, the exemplary apparatus may control or interact with all connected external source devices with a remote control via the display screen.

According to yet another embodiment of the present invention, the exemplary apparatus further comprises a management module, for managing an external source device coupled to the network module or the multimedia interface switch module. The management module includes a content management unit, a device management unit, or a remote service management unit. In this embodiment, the management module performs a conversion between an HDMI support protocol and home network management protocols.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a typical HDMI applications with HEC enabled.

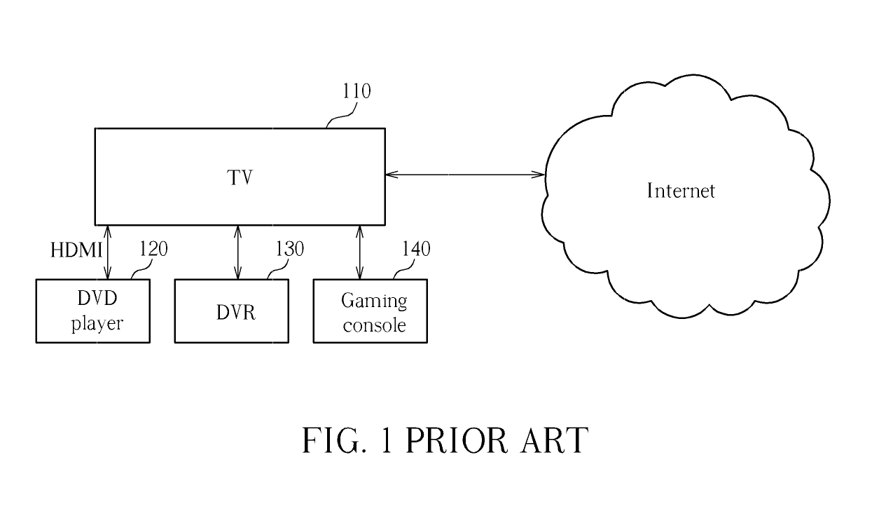

FIG. 2 is a block diagram illustrating an exemplary apparatus according to an embodiment of the present invention.

FIG. 3 is a diagram illustrating data transmission of an HDMI-integrated switch-router according to an embodiment of the present invention.

FIG. 4 is a diagram illustrating an exemplary media-appliance manager device according to an embodiment of the present invention.

FIG. 5 is a diagram illustrating an exemplary apparatus according to another embodiment of the present invention.

FIG. 6 is a diagram illustrating an exemplary apparatus according to another embodiment of the present invention.

FIG. 7 is a diagram illustrating an exemplary HDMI-integrated switch-router according to another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

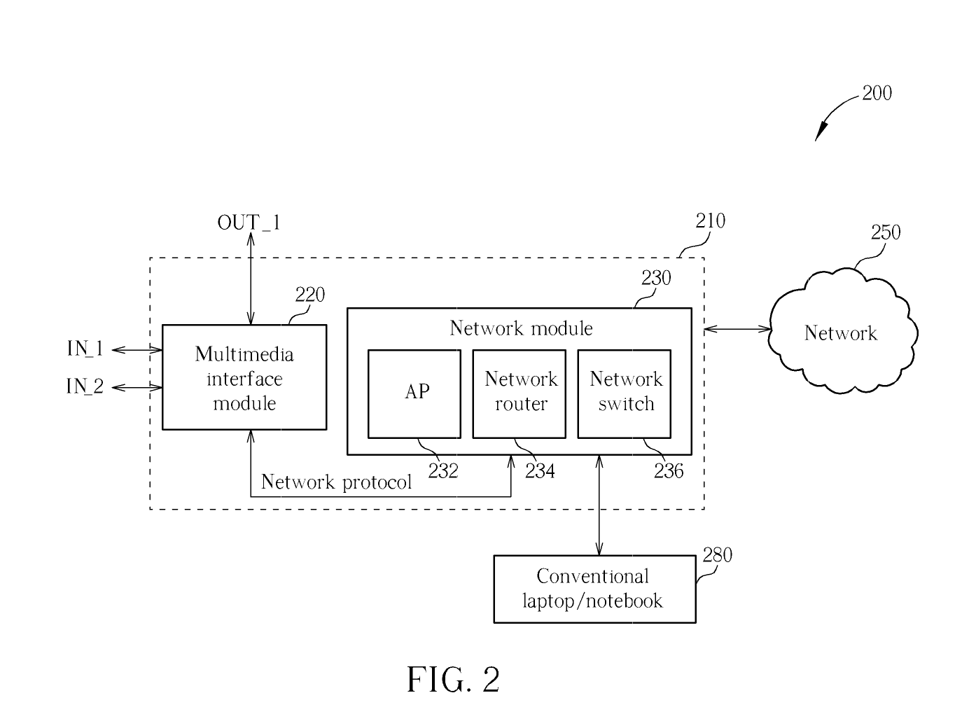

Please refer to FIG. 2, which is a block diagram illustrating an exemplary apparatus 200 according to an embodiment of the present invention. The apparatus 200 includes a housing 210, a multimedia interface module 220, and a network module 230. The multimedia interface module 220 is disposed in the housing 210, and has a plurality of connection ports including at least an input port (e.g., IN_1 and IN_2) and at least an output port (e.g., OUT_1), wherein the multimedia interface module 220 supports network data transmission. The network module 230 is disposed in the housing 210 and used for accessing a network (e.g., Internet) 250. As shown in FIG. 2, the network module 230 is coupled to the multimedia interface module 220 via a first network protocol. By way of example, but not limitation, the network module 230 may include an access point (AP) 232, a network router 234, and/or a network switch 236. With the aid of the network module 230, the apparatus 200 may thus communicate with the network 250 in a wireless or a wired manner. In a case where the network 250 is Internet, the network module 230 may access the Internet via Internet Protocol (IP) in the wireless manner when the AP 232 is enabled. Similarly, the network module 230 may access the Internet via IP in the wired manner when the network router 234 (e.g. an IP router) or the network switch 236 (e.g. an Ethernet switch) is enabled. To put it simply, the apparatus 200 is capable of routing and/or switching IP-based data traffic.

In addition, the multimedia interface module 220 is arranged for selectively coupling the network module 230 to one of the connection ports. As the multimedia interface module 220 supports the network data transmission, data transmitted in the apparatus 200 may be composed of network-related multimedia interface data and non network-related multimedia interface data. When multimedia interface data is transmitted, the apparatus 200 only transfers the non network-related multimedia interface data to a multimedia-interface-enabled audio/video output apparatus (e.g., a television) for audio/video playback of an output generated from the output port OUT_1 of the apparatus 200, and at least the input port may be coupled to at least the output port in this case. The multimedia interface module 220 may couple the network module 230 to at least the input port for transmitting the network-related multimedia interface data to the network module 230. As the apparatus 200 may also communicate with at least an external source device via a second network protocol, where the external source device (e.g., a conventional laptop/notebook 280) does not support network-related multimedia interface data transmission of the multimedia interface, the network-related multimedia interface data is processed by the network module 230 together with other network data from the external source device, and the multimedia interface module 220 may couple the network module 230 to at least the output port for outputting the processed network-related multimedia interface data. In addition, the apparatus 200 may be externally coupled to or internally built in the above-mentioned audio/video output apparatus. Further description for the data transmission is detailed as follows.

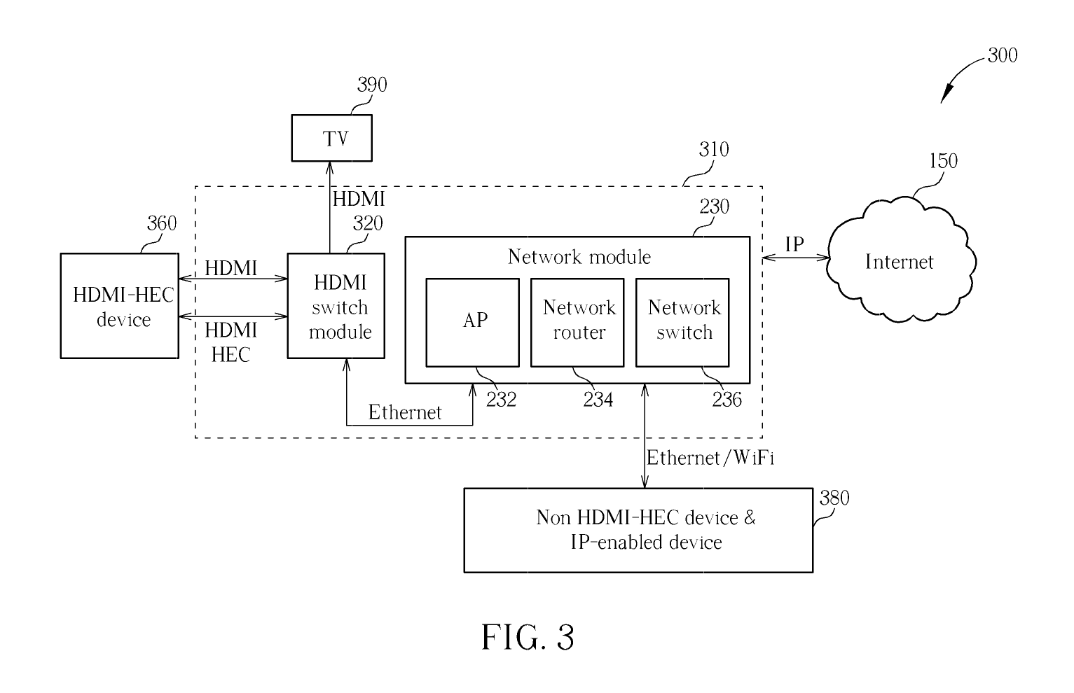

Please refer to FIG. 3, which is a diagram illustrating data transmission of an HDMI-integrated switch-router 300 according to an embodiment of the present invention. The HDMI-integrated switch-router 300 is based on the architecture of the apparatus 200 shown in FIG. 2, and therefore includes a housing 310, an HDMI switch module 320, and a network module 230. The HDMI switch module 320 complies with an HDMI specification supporting an HDMI Ethernet channel (HEC), such as HDMI v1.4 specification. The network module 230 is coupled to the HDMI switch module 320 via the Ethernet signal split form HEC-related HDMI data. The network module 230 includes an access point (AP) 232, a network router 234, and a network switch 236. The HDMI-integrated switch-router 300 may thus communicate with Internet 150 in a wireless or a wired manner. As shown in FIG. 3, the HDMI-integrated switch-router 300 may be regarded as an HDMI switch with network packet switching functionality, network packet routing functionality, and access point functionality. The HDMI-integrated switch-router 300 supports an HDMI device complying with HEC (i.e., an HDMI-HEC device) 360, an HDMI device not complying with HEC (i.e., a non HDMI-HEC device) and an IP-enabled device not supporting HDMI (i.e., an IP-enabled device) 380. In this embodiment, HDMI-HEC devices are connected through HDMI switch module 320; besides, non HDMI-HEC devices, including IP-enabled devices, are connected through wired connection (e.g., Ethernet) or wireless connection (e.g., WiFi).

The HDMI-integrated switch-router 300 transfers non HEC-related HDMI data of the HDMI-HEC device 360 to the HDMI-enabled TV 390 for video/audio playback. HEC-related HDMI data of the HDMI-HEC device 360 is transferred to the network module 230 via Ethernet signal split by HDMI switch module 320, and is processed together with Ethernet/wireless data from the non HDMI-HEC device and the IP-enabled device 380. As the HDMI-HEC device 360 may update playback contents according to Internet 150, desired packets may be downloaded from the Internet 150 and then transferred from the network module 230 to HDMI switch module 320 via Ethernet signal. After receiving and processing the desired packets into HEC-related HDMI data by the HDMI switch module 320, the HDMI-HEC device 360 updates and transfers the non HEC-related HDMI data, thereby updating the playback contents of the HDMI-enabled TV 390. Similarly, the non HDMI-HEC device and the IP-enabled device 380 may receive and process desired packets from the Internet 150 through the network module 230, and then transfer the updated non HEC-related HDMI data to update the playback contents of the HDMI-enabled TV 390 via Ethernet signal and the HDMI switch module 320. In addition, the HDMI-HEC device 360, the non HDMI-HEC device and the IP-enabled device 380 may communicate with each other or connect to internet via Ethernet signal and the network module 230. In other words, the connection between the multimedia interface module (e.g., the HDMI switch module 320) and the network module (e.g., the network module 230) may a two-way transfer under the exemplary apparatus according to the present invention.

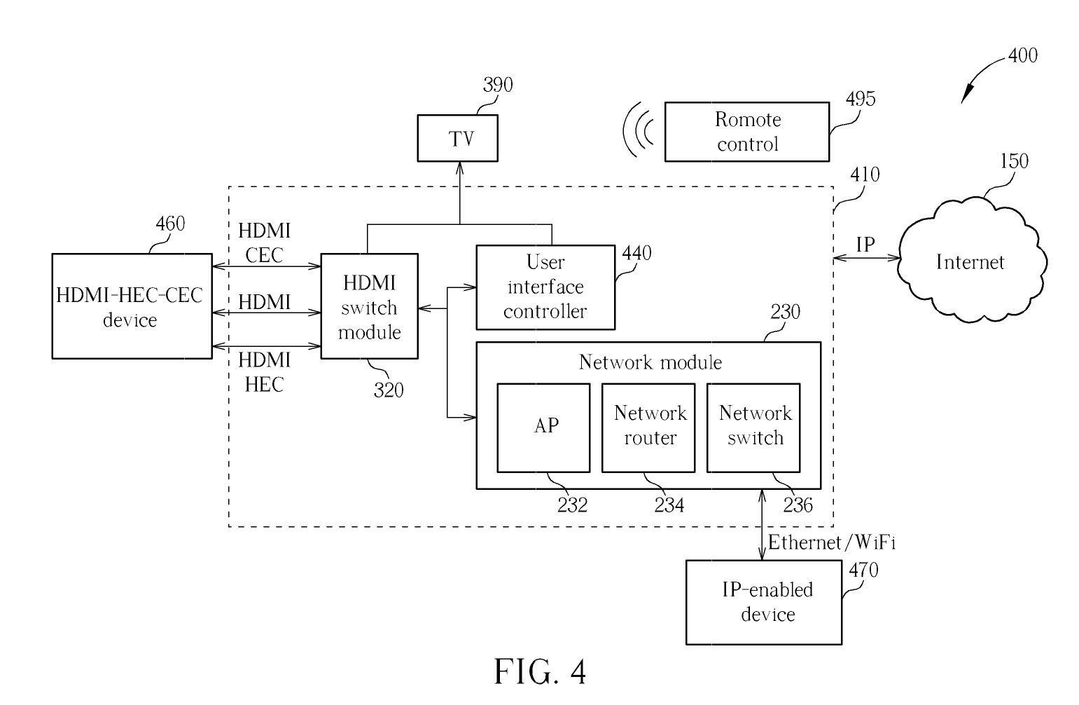

Please refer to FIG. 4, which is a diagram illustrating an exemplary media-appliance manager device 400 according to an embodiment of the present invention. The exemplary media-appliance manager device 400 is based on the architecture of the multimedia interface apparatus 300 shown in FIG. 3, and therefore includes, but is not limited to, a housing 410, the aforementioned HDMI switch module 320 and network module 230, and a user interface controller 440. The user interface controller 440 is coupled to the network module 230, and used to generate a first control signal according to a user input signal, for example, generated by a remote control 495, and transmit a second control signal to an external source device (e.g., an IP-enabled device 470) coupled to the network module 230, wherein the IP-enabled device 470 does not support HEC or consumer electronic control (CEC). The HDMI switch module 320 complies with an HDMI specification supporting HEC (e.g., HDMI v1.4 specification), and is coupled to an HDMI-HEC device complying with CEC (i.e., an HDMI-HEC-CEC device 460). The first control signal complies with a specific control format dedicated to a multimedia interface (e.g., HDMI). In this embodiment, the user interface controller 440 may convert the first control signal with CEC format into the second control signal with a network protocol format suitable for wired transmission (e.g., Ethernet) or wireless transmission (e.g., WiFi).

In addition, the user interface controller 440 may further drive a display screen (e.g., TV 390) to display a user interface thereon via HDMI interface, and the user input signal is generated according to the displayed user interface. With the use of the remote control 495, a user may locate, configure, and/or manage external source devices through the media-appliance manager device 500. By way of example, the user may enable the CEC function by the remote control 495 to thereby manage external sources, including the HDMI-HEC-CEC device 460 and the IP-enabled device 470 not supporting CEC, and then the user interface controller 440 converts the first control signal with a CEC format into the second control signal with an IP format. In a case where the user may want to monitor carbon monoxide concentration in the house remotely, the user may only press a button on the remote control 495, and then the user interface controller 440 may receive a sensor input signal generated from a carbon monoxide sensor device (e.g., the IP-enabled device 470 implemented using the carbon monoxide sensor device) coupled to the network module 230 wirelessly, and drive the display screen to display the carbon monoxide concentration according to the sensor input signal. In this embodiment, the media-appliance manager 400 may be an aggregator for devices and services, and the media-appliance manager 400 may control or interact with all connected external source devices with the remote control 495 via the display screen.

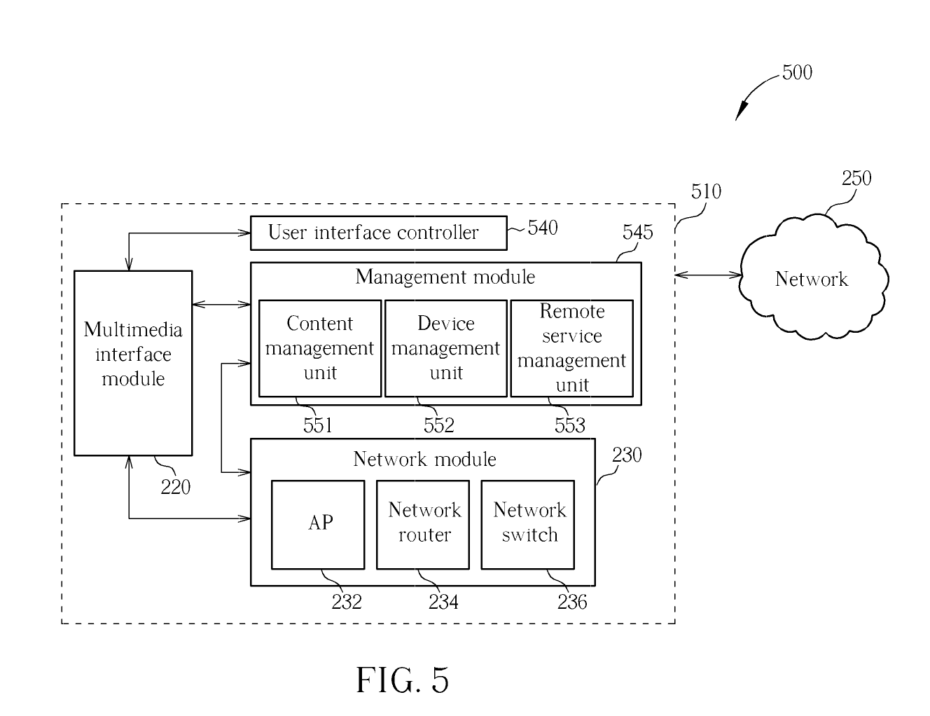

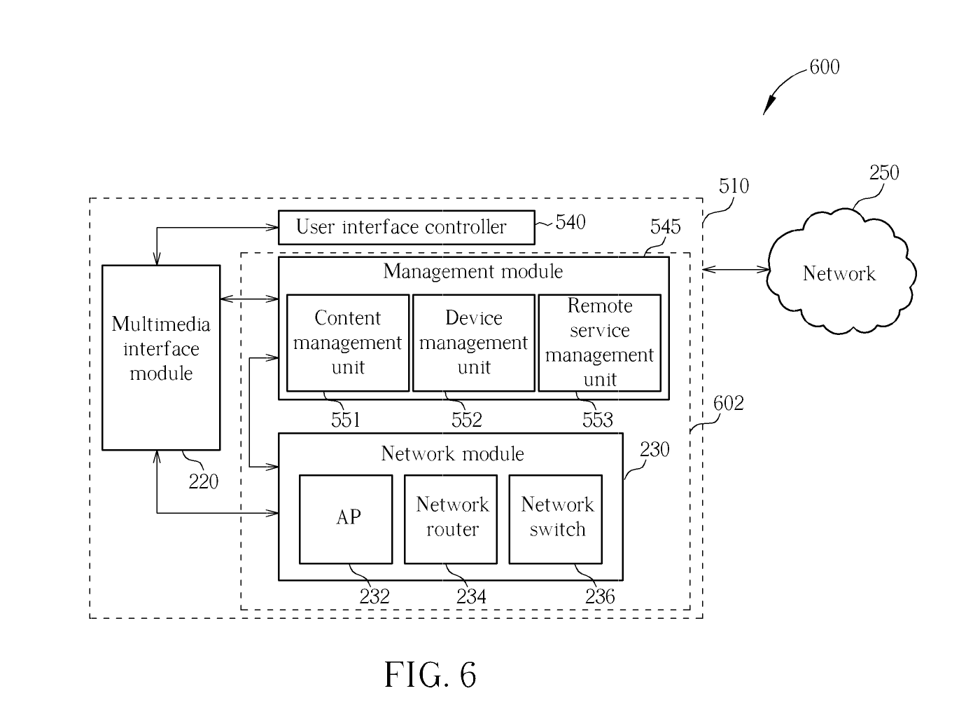

Please refer to FIG. 5, which is a diagram illustrating an exemplary apparatus 500 according to another embodiment of the present invention. The exemplary apparatus 500 is utilized as a management scheme and partially based on the architecture of the apparatus 200 shown in FIG. 2. The apparatus 500 includes, but is not limited to, a housing 510, the aforementioned multimedia interface module 220, network module 230, and user interface controller 540, and a management module 545. The management module 545 is coupled to the multimedia interface module 220 and the network module 230, and used for managing the layer 3 (i.e., the network layer in Open System Interconnection (OSI) model) data from an external source device coupled to the network module 230 or the multimedia interface module 220, and the management module 545 may include a content management unit 551, a device management unit 552, and/or a remote service management unit 553. For example, the content management unit 551 may be related to Digital Right Management (DRM), Open Service Gateway Initiative (OSGI), etc., the device management unit 552 may be related to Digital Living Network Alliance (DLNA), Universal Plug and Play (UPnP), etc., and the remote service management unit 553 may be related to Simple Network Management Protocol (SNMP), Open Mobile Alliance-Device Management (OAM-DM), etc. In an alternative design as shown in FIG. 6, which is a diagram illustrating an exemplary apparatus 600 according to another embodiment of the present invention, the management module 545 may also be integrated with the network module 230 in an integrated circuit 602.

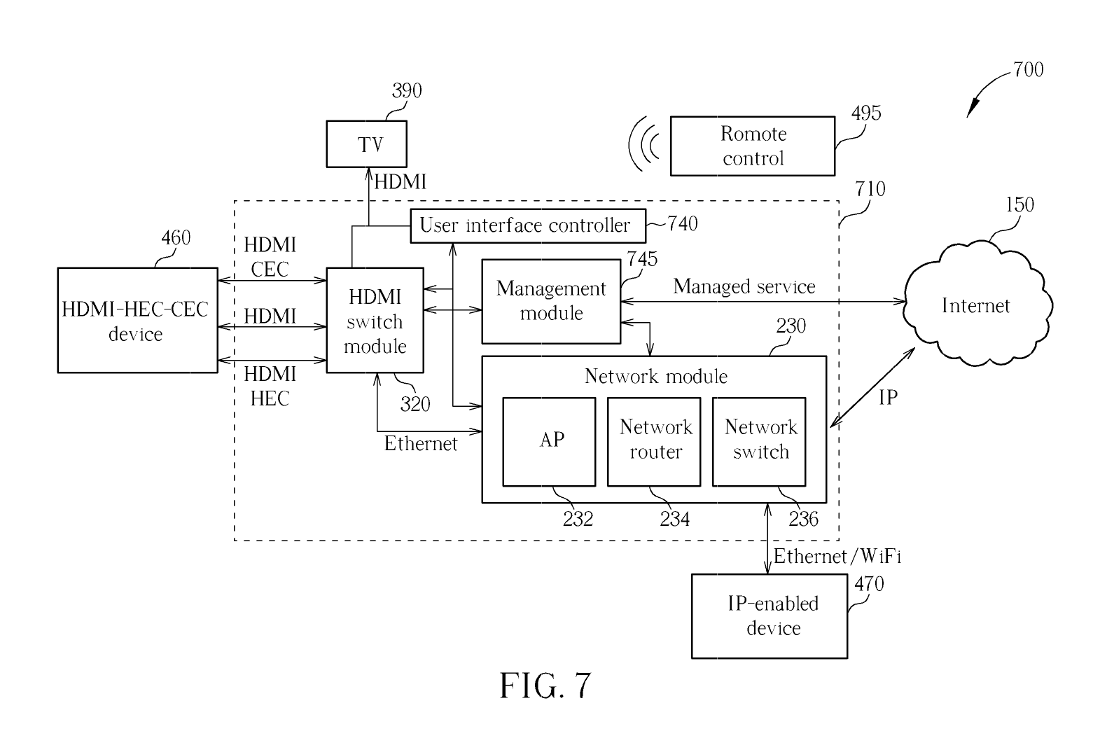

Please refer to FIG. 7, which is a diagram illustrating an exemplary HDMI-integrated switch-router 700 according to another embodiment of the present invention. The exemplary HDMI-integrated switch-router 700 is based on the architecture of the apparatus 500 shown in FIG. 5. In this embodiment, using a management scheme for bridging HDMI CEC/HEC and other IP management protocols allows service providers/users to manage contents and services provided to all connected external source devices. The IP connectivity is also aggregated to an easier connection. The HDMI-integrated switch-router 700 includes a housing 710, the aforementioned HDMI switch module 320 and network module 230, a user interface controller 740, and a management module 745. The management module 745 may transmit protocols and perform a conversion between an HDMI support protocol (e.g., a protocol with HDMI CEC and/or HEC format) and home network management protocols (e.g., management protocols from service providers or home devices). By way of example, while the IP-enabled device 470 (e.g. an IP Set-Top Box) orders the content (e.g., voice, video, game, etc.) streamed from a service provider, the management module 745 converts the management protocols to HEC and/or CEC data via the HDMI switch module 320, so that the service provider may manage services and also feedback to user interface controller 740 or to access other devices, for example, the HDMI-HEC-CEC device 460.

As shown in FIG. 7, the HDMI-integrated switch-router 700 may be configured to support all of the technical features mentioned above. That is, the HDMI-integrated switch-router 700 may be regarded as an integration of the management scheme as shown in FIG. 7, elements within the HDMI-integrated switch-router 300, and elements within the media-appliance manager device 400. Please note that the remote control 495 may be optional. For example, the user input signal may be directly generated from the TV 390 when the user touches a touch panel of the TV 390 or presses button(s) on the TV 390. In this embodiment, home network and management with HDMI-integrated is accomplished.

In summary, an apparatus, employing a multimedia interface switch module supporting network data transmission (e.g., an HDMI v1.4 switch) integrated with a network module having network functionality (e.g., network packet switching functionality, network packet routing functionality, and/or access point functionality) by a network protocol therebetween, is disclosed to allow various devices to display respective contents on an audio/video output apparatus. In addition, a media-appliance manager device is realized utilizing the format conversion between a specific control signal and a network protocol. Moreover, with the help of a management scheme added to the apparatus, the user may utilize the apparatus to manage other devices through a screen of an audio/video output apparatus or even remotely manage value-added services. Network protocol connectivity is also aggregated to an easier connection.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An apparatus, comprising:
a multimedia interface module, having a plurality of connection ports including at least an input port and at least an output port, wherein the multimedia interface module supports network data transmission; and
a network module, coupled to the multimedia interface module via a first network protocol, for accessing a network, wherein the multimedia interface module is arranged for selectively coupling the network module to one of the connection ports.

2. The apparatus of claim 1, wherein the network module comprises:
an access point (AP), for communicating with the network in a wireless manner.

3. The apparatus of claim 1, wherein the network module comprises:
a network router, for communicating with the network in a wired manner.

4. The apparatus of claim 1, wherein the network module comprises:
a network switch, for communicating with the network in a wired manner.

5. The apparatus of claim 1, wherein the multimedia interface module is for transferring non network-related multimedia interface data to a multimedia interface-enabled audio/video output apparatus for audio/video playback of an output generated from the output port of the apparatus, and network-related multimedia interface data is processed by the network module.

6. The apparatus of claim 1, wherein the multimedia interface module is a High-Definition Multimedia Interface (HDMI) switch complying with an HDMI specification supporting an HDMI Ethernet channel (HEC).

7. The apparatus of claim 1, wherein the network module communicates with at least an external source device via a second network protocol, and the external source device does not support network-related multimedia interface data.

8. The apparatus of claim 7, wherein the external source device is an HDMI device or an Internet Protocol-enabled (IP-enabled) device not supporting HDMI.

9. The apparatus of claim 1, further comprising:
a user interface controller, coupled to the network module, for generating a first control signal according to a user input signal, and transmitting a second control signal to an external source device coupled to the network module.

10. The apparatus of claim 9, wherein the user interface controller converts the first control signal with a consumer electronic control (CEC) format into the second control signal with a network protocol format.

11. The apparatus of claim 9, wherein the user interface controller further drives a display screen to display a user interface, and the user input signal is generated according to the displayed user interface.

12. The apparatus of claim 1, further comprising:
a user interface controller, coupled to the network module, for receiving a sensor input signal generated from a sensor device coupled to the network module, and driving a display screen to display information of the sensor device according to the sensor input signal.

13. The apparatus of claim 1, further comprising:
a management module, for managing an external source device coupled to the network module or the multimedia interface module.

14. The apparatus of claim 13, wherein the management module is integrated with the network module in an integrated circuit.

15. The apparatus of claim 13, wherein the management module comprises a content management unit, a device management unit, or a remote service management unit.

16. The apparatus of claim 13, wherein the multimedia interface module is a High-Definition Multimedia Interface (HDMI) switch complying with an HDMI specification supporting an HDMI Ethernet channel (HEC), and the management module performs a conversion between an HDMI support protocol and home network management protocols.

17. The apparatus of claim 16, wherein the HDMI support protocol complies with an HDMI Ethernet channel (HEC) format, or a consumer electronic control (CEC) format.

18. The apparatus of claim 1, being externally coupled to an audio/video output apparatus for audio/video playback of an output generated from the output port of the apparatus.

19. The apparatus of claim 1, being built in an audio/video output apparatus for audio/video playback of an output generated from the output port of the apparatus.

20. The apparatus of claim 1, being controlled or interacted with at least an external source device, wherein the external source device is coupled to the network module or the multimedia interface module via an audio/video output apparatus.
